(19) United States
(12) Patent Application Publication
(10) Pub. No.: US 2026/0220266 A1
(43) Pub. Date: Jul. 30, 2026

(54) DETECTION OF ANOMALOUS WRITE PATTERNS IN A WRITE JOURNAL OF A STORAGE SYSTEM

(71) Applicant: Dell Products L.P., Round Rock, TX (US)

(72) Inventors: Wai Yim, Merrimack, NH (US); Tommi Salli, Austin, TX (US)

(21) Appl. No.: 19/037,475

(22) Filed: Jan. 27, 2025

(51) Int. Cl. G06F 21/56

(52) U.S. Cl. CPC G06F 21/566; G06F 2221/034

(57) ABSTRACT

An apparatus comprises at least one processing device configured to monitor a pattern of write operations in a write journal of a storage system, the write operations being directed to storage objects in the storage system, the write journal queueing the write operations prior to the write operations being flushed to one or more storage devices of the storage system. The at least one processing device is also configured to detect, based at least in part on the monitored pattern of write operations in the write journal of the storage system, an anomalous write pattern indicative of an attack on the storage system. The at least one processing device is further configured, responsive to detecting the anomalous write pattern, to prevent one or more of the write operations in the write journal of the storage system from being flushed to the one or more storage devices of the storage system.

### BACKGROUND

Information processing systems may be configured to incorporate security functionality in order to protect data stored in one or more storage arrays or other types of storage systems of the information processing systems against malicious activity. Such malicious activity may include, for example, “ransomware” attacks in which an attacker, via one or more computing devices which may be part of or otherwise in communication with the storage systems, will systematically encrypt files or other data stored in the storage systems. The attacker withholds a corresponding decryption key unless a ransom is paid by the victim.

### SUMMARY

Illustrative embodiments of the present disclosure provide techniques for detection of anomalous write patterns in a write journal of a storage system.

In one embodiment, an apparatus comprises at least one processing device comprising a processor coupled to a memory. The at least one processing device is configured to monitor a pattern of write operations in a write journal of a storage system, the write operations being directed to one or more storage objects in the storage system, the write journal queueing the write operations prior to the write operations being flushed to one or more storage devices of the storage system. The at least one processing device is also configured to detect, based at least in part on the monitored pattern of write operations in the write journal of the storage system, an anomalous write pattern indicative of an attack on the storage system. The at least one processing device is further configured, responsive to detecting the anomalous write pattern, to prevent one or more of the write operations in the write journal of the storage system from being flushed to the one or more storage devices of the storage system.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for detection of anomalous write patterns in a write journal of a storage system in an illustrative embodiment.

FIG. 2 is a flow diagram of an exemplary process for detection of anomalous write patterns in a write journal of a storage system in an illustrative embodiment.

FIG. 3 shows a storage system configured for ransomware detection based on analyzing patterns of reads and writes in a storage journal in an illustrative embodiment.

FIGS. 4 and 5 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

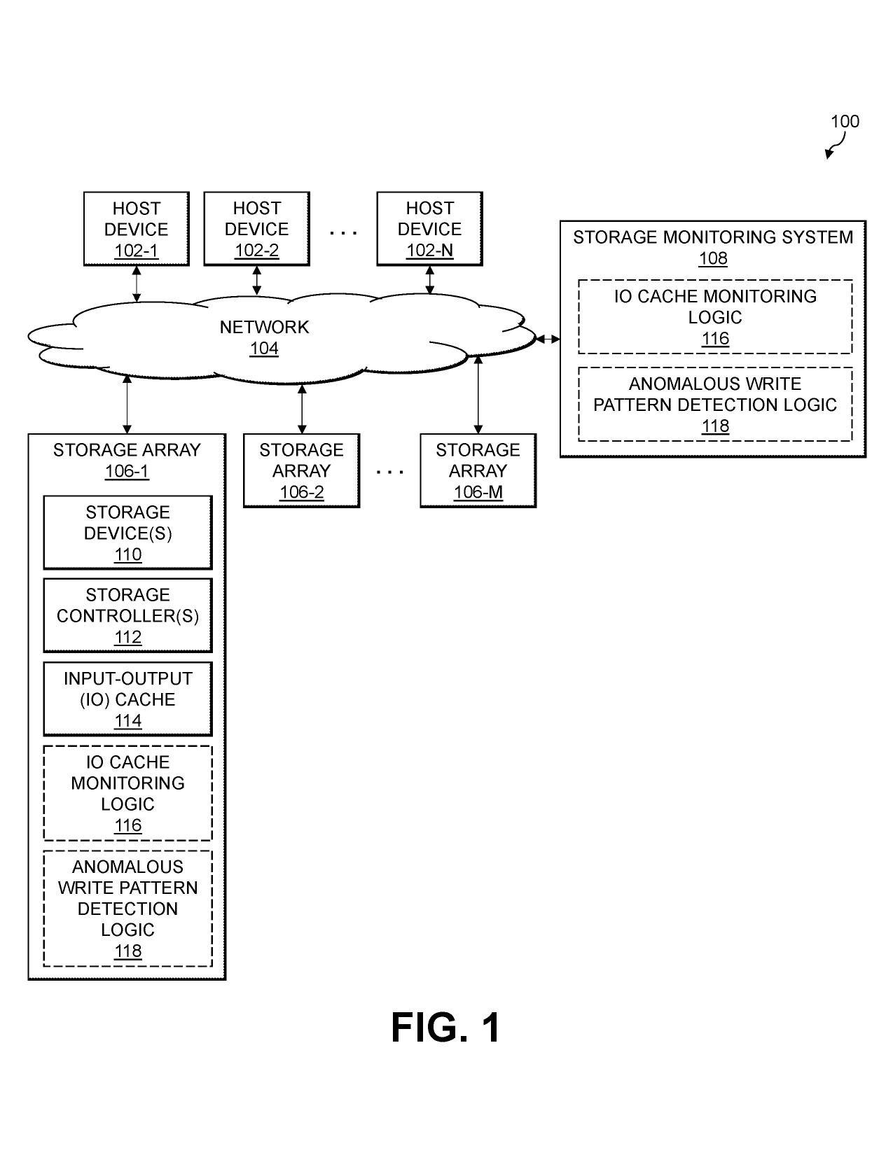

FIG. 1 shows an information processing system 100 configured in accordance with an illustrative embodiment to provide functionality for detection of anomalous write patterns in a write journal of a storage system. The information processing system 100 comprises one or more host devices 102-1, 102-2, . . . 102-N (collectively, host devices 102) that communicate over a network 104 with one or more storage arrays 106-1, 106-2, . . . 106-M (collectively, storage arrays 106). The network 104 may comprise a storage area network (SAN). Also coupled to the network 104 is a storage monitoring system 108, which may be configured to provide monitoring services for one or more of the storage arrays 106.

The storage array 106-1, as shown in FIG. 1, comprises a plurality of storage devices 110 each storing data utilized by one or more applications running on the host devices 102. The storage devices 110 are illustratively arranged in one or more storage pools. The storage array 106-1 also comprises one or more storage controllers 112 that facilitate IO processing for the storage devices 110, as well as an input-output (IO) cache 114. The IO cache 114 is configured to implement caches for read and write operations, such as in the form of a storage journal as described elsewhere herein. The storage array 106-1 and its associated storage devices 110 are an example of what is more generally referred to herein as a “storage system.” This storage system in the present embodiment is shared by the host devices 102, and is therefore also referred to herein as a “shared storage system.” In embodiments where there is only a single host device 102, the host device 102 may be configured to have exclusive use of the storage system. In some embodiments, the storage arrays 106 may be part of a storage cluster (e.g., where the storage arrays 106 may be used to implement one or more storage nodes in a cluster storage system comprising a plurality of storage nodes interconnected by one or more networks), and the host devices 102 are assumed to submit IO operations to be processed by the storage cluster.

The host devices 102 illustratively comprise respective computers, servers or other types of processing devices capable of communicating with the storage arrays 106 via the network 104. For example, at least a subset of the host devices 102 may be implemented as respective virtual machines of a compute services platform or other type of processing platform. The host devices 102 in such an arrangement illustratively provide compute services such as execution of one or more applications on behalf of each of one or more users associated with respective ones of the host devices 102.

The term “user” herein is intended to be broadly construed so as to encompass numerous arrangements of human, hardware, software or firmware entities, as well as combinations of such entities.

Compute and/or storage services may be provided for users under a Platform-as-a-Service (PaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

The storage devices 110 of the storage array 106-1 may implement logical units (LUNs) configured to store objects for users associated with the host devices 102. These objects can comprise files, blocks or other types of objects. The host devices 102 interact with the storage array 106-1 utilizing read and write commands as well as other types of commands that are transmitted over the network 104. Such commands in some embodiments more particularly comprise Small Computer System Interface (SCSI) commands, although other types of commands can be used in other embodiments. A given IO operation as that term is broadly used herein illustratively comprises one or more such commands. References herein to terms such as “input-output” and “IO” should be understood to refer to input and/or output. Thus, an IO operation relates to at least one of input and output.

Also, the term “storage device” as used herein is intended to be broadly construed, so as to encompass, for example, a logical storage device such as a LUN or other logical storage volume. A logical storage device can be defined in the storage array 106-1 to include different portions of one or more physical storage devices. Storage devices 110 may therefore be viewed as comprising respective LUNs or other logical storage volumes.

The storage devices 110 of the storage array 106-1 can be implemented using solid state drives (SSDs). Such SSDs are implemented using non-volatile memory (NVM) devices such as flash memory. Other types of NVM devices that can be used to implement at least a portion of the storage devices 110 include non-volatile random-access memory (NVRAM), phase-change RAM (PC-RAM) and magnetic RAM (MRAM). These and various combinations of multiple different types of NVM devices or other storage devices may also be used. For example, hard disk drives (HDDs) can be used in combination with or in place of SSDs or other types of NVM devices. Accordingly, numerous other types of electronic or magnetic media can be used in implementing at least a subset of the storage devices 110.

At least one of the storage controllers of the storage arrays 106 (e.g., the storage controller 112 of storage array 106-1) is assumed to implement functionality for detection of anomalous write patterns in a write journal for its associated one of the storage arrays 106. Such functionality is provided via IO cache monitoring logic 116 and anomalous write pattern detection logic 118. In other embodiments, the anomalous write pattern detection functionality may be implemented on the storage monitoring system 108. In still other embodiments, the anomalous write pattern detection functionality may be implemented at least in part on one or more of the storage arrays 106 and on the storage monitoring system 108. Thus, as shown in FIG. 1, the IO cache monitoring logic 116 and the anomalous write pattern detection logic 118 are shown in dashed outline in both the storage array 106-1 and the storage monitoring system 108. Although not shown in FIG. 1, other ones of the storage arrays 106-2 through 106-M may be configured with storage devices, storage controllers, IO caches and may implement instances of the IO cache monitoring logic 116 and the anomalous write pattern detection logic 118.

The IO cache monitoring logic 116 is configured to monitor a pattern of write operations in a write journal of the IO cache 114. The write journal queues the write operations, directed to one or more storage objects in the storage array 106-1, prior to the write operations being flushed from the IO cache 114 to the storage devices 110. The IO cache monitoring logic 116 may also be configured to monitor a pattern of read operations in a read cache of the IO cache 114, where the read operations are also directed to one or more storage objects in the storage array 106-1. The anomalous write pattern detection logic 118 is configured to detect, based at least in part on the monitored pattern of write operations in the write journal, an anomalous write pattern indicative of an attack on the storage system. The detection of the anomalous write pattern indicative of the attack on the storage system may also be based at least in part on the monitored pattern of read operations in the read cache. The anomalous write pattern detection logic 118 is further configured, responsive to detecting the anomalous write pattern, to prevent one or more of the write operations in the write journal of the IO cache 114 from being flushed to the storage devices 110.

In some embodiments, the storage arrays 106 in the FIG. 1 embodiment provide or implement multiple distinct storage tiers of a multi-tier storage system. By way of example, a given multi-tier storage system may comprise a fast tier or performance tier implemented using flash storage devices or other types of SSDs, and a capacity tier implemented using HDDs, possibly with one or more such tiers being server based. A wide variety of other types of storage devices and multi-tier storage systems can be used in other embodiments, as will be apparent to those skilled in the art. The particular storage devices used in a given storage tier may be varied depending on the particular needs of a given embodiment, and multiple distinct storage device types may be used within a single storage tier. As indicated previously, the term “storage device” as used herein is intended to be broadly construed, and so may encompass, for example, SSDs, HDDs, flash drives, hybrid drives or other types of storage products and devices, or portions thereof, and illustratively include logical storage devices such as LUNs.

It should be appreciated that a multi-tier storage system may include more than two storage tiers, such as one or more “performance” tiers and one or more “capacity” tiers, where the performance tiers illustratively provide increased IO performance characteristics relative to the capacity tiers and the capacity tiers are illustratively implemented using relatively lower cost storage than the performance tiers. There may also be multiple performance tiers, each providing a different level of service or performance as desired, or multiple capacity tiers.

Although in the FIG. 1 embodiment the IO cache monitoring logic 116 and the anomalous write pattern detection logic 118 are shown as being implemented internal to the storage array 106-1 and outside the storage controllers 112, in other embodiments one or both of the IO cache monitoring logic 116 and the anomalous write pattern detection logic 118 may be implemented at least partially internal to the storage controllers 112 or at least partially outside the storage array 106-1, such as on the storage monitoring system 108, on one of the host devices 102, on one or more other ones of the storage arrays 106-2 through 106-M, on one or more servers external to the host devices 102 and the storage arrays 106 (e.g., including on a cloud computing platform or other type of information technology (IT) infrastructure), etc.

At least portions of the functionality of the IO cache monitoring logic 116 and the anomalous write pattern detection logic 118 may be implemented at least in part in the form of software that is stored in memory and executed by a processor.

The host devices 102, the storage arrays 106 and the storage monitoring system 108 in the FIG. 1 embodiment are assumed to be implemented using at least one processing platform, with each processing platform comprising one or more processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The host devices 102, the storage arrays 106 and the storage monitoring system 108 may be implemented on respective distinct processing platforms, although numerous other arrangements are possible. For example, in some embodiments at least portions of one or more of the host devices 102, one or more of the storage arrays 106 and/or the storage monitoring system 108 are implemented on the same processing platform. One or more of the storage arrays 106 can therefore be implemented at least in part within at least one processing platform that implements at least a subset of the host devices 102 and/or the storage monitoring system 108.

The network 104 may be implemented using multiple networks of different types to interconnect storage system components. For example, the network 104 may comprise a SAN that is a portion of a global computer network such as the Internet, although other types of networks can be part of the SAN, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Although in some embodiments certain commands used by the host devices 102 to communicate with the storage arrays 106 illustratively comprise SCSI commands, other types of commands and command formats can be used in other embodiments. For example, some embodiments can implement IO operations utilizing command features and functionality associated with NVM Express (NVMe), as described in the NVMe Specification, Revision 1.3, May 2017, which is incorporated by reference herein. Other storage protocols of this type that may be utilized in illustrative embodiments disclosed herein include NVMe over Fabric, also referred to as NVMeoF, and NVMe over Transmission Control Protocol (TCP), also referred to as NVMe/TCP.

The storage array 106-1 in the present embodiment is assumed to comprise a persistent memory that is implemented using a flash memory or other type of non-volatile memory of the storage array 106-1. More particular examples include NAND-based flash memory or other types of non-volatile memory such as resistive RAM, phase change memory, and spin torque transfer magneto-resistive RAM (STT-MRAM). The persistent memory is further assumed to be separate from the storage devices 110 of the storage array 106-1, although in other embodiments the persistent memory may be implemented as a designated portion or portions of one or more of the storage devices 110. For example, in some embodiments the storage devices 110 may comprise flash-based storage devices, as in embodiments involving all-flash storage arrays, or may be implemented in whole or in part using other types of non-volatile memory.

As mentioned above, communications between the host devices 102 and the storage arrays 106 may utilize PCIe connections or other types of connections implemented over one or more networks. For example, illustrative embodiments can use interfaces such as Internet SCSI (iSCSI), Serial Attached SCSI (SAS) and Serial ATA (SATA). Numerous other interfaces and associated communication protocols can be used in other embodiments.

The storage arrays 106 in some embodiments may be implemented as part of a cloud-based system. The storage monitoring system 108 may also or alternatively be implemented as part of the cloud-based system.

It should therefore be apparent that the term “storage array” as used herein is intended to be broadly construed, and may encompass multiple distinct instances of a commercially-available storage array.

Other types of storage products that can be used in implementing a given storage system in illustrative embodiments include software-defined storage, cloud storage, object-based storage and scale-out storage. Combinations of multiple ones of these and other storage types can also be used in implementing a given storage system in an illustrative embodiment.

In some embodiments, a storage system comprises first and second storage arrays arranged in an active-active configuration. For example, such an arrangement can be used to ensure that data stored in one of the storage arrays is replicated to the other one of the storage arrays utilizing a synchronous replication process. Such data replication across the multiple storage arrays can be used to facilitate failure recovery in the system 100. One of the storage arrays may therefore operate as a production storage array relative to the other storage array which operates as a backup or recovery storage array.

It is to be appreciated, however, that embodiments disclosed herein are not limited to active-active configurations or any other particular storage system arrangements. Accordingly, illustrative embodiments herein can be configured using a wide variety of other arrangements, including, by way of example, active-passive arrangements, active-active Asymmetric Logical Unit Access (ALUA) arrangements, and other types of ALUA arrangements.

These and other storage systems can be part of what is more generally referred to herein as a processing platform comprising one or more processing devices each comprising a processor coupled to a memory. A given such processing device may correspond to one or more virtual machines or other types of virtualization infrastructure such as Docker containers or other types of LXCs. As indicated above, communications between such elements of system 100 may take place over one or more networks.

The term “processing platform” as used herein is intended to be broadly construed so as to encompass, by way of illustration and without limitation, multiple sets of processing devices and one or more associated storage systems that are configured to communicate over one or more networks. For example, distributed implementations of the host devices 102 are possible, in which certain ones of the host devices 102 reside in one data center in a first geographic location while other ones of the host devices 102 reside in one or more other data centers in one or more other geographic locations that are potentially remote from the first geographic location. The storage arrays 106 and the storage monitoring system 108 may be implemented at least in part in the first geographic location, the second geographic location, and one or more other geographic locations. Thus, it is possible in some implementations of the system 100 for different ones of the host devices 102, the storage arrays 106 and the storage monitoring system 108 to reside in different data centers.

Numerous other distributed implementations of the host devices 102, the storage arrays 106 and the storage monitoring system 108 are possible. Accordingly, the host devices 102, the storage arrays 106 and the storage monitoring system 108 can also be implemented in a distributed manner across multiple data centers.

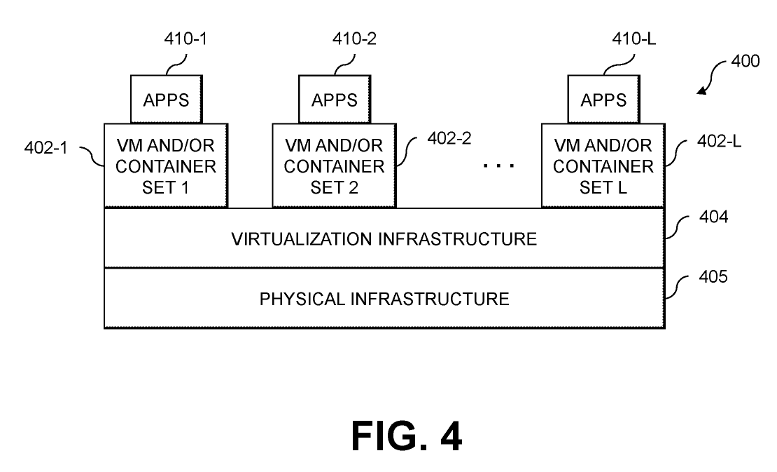

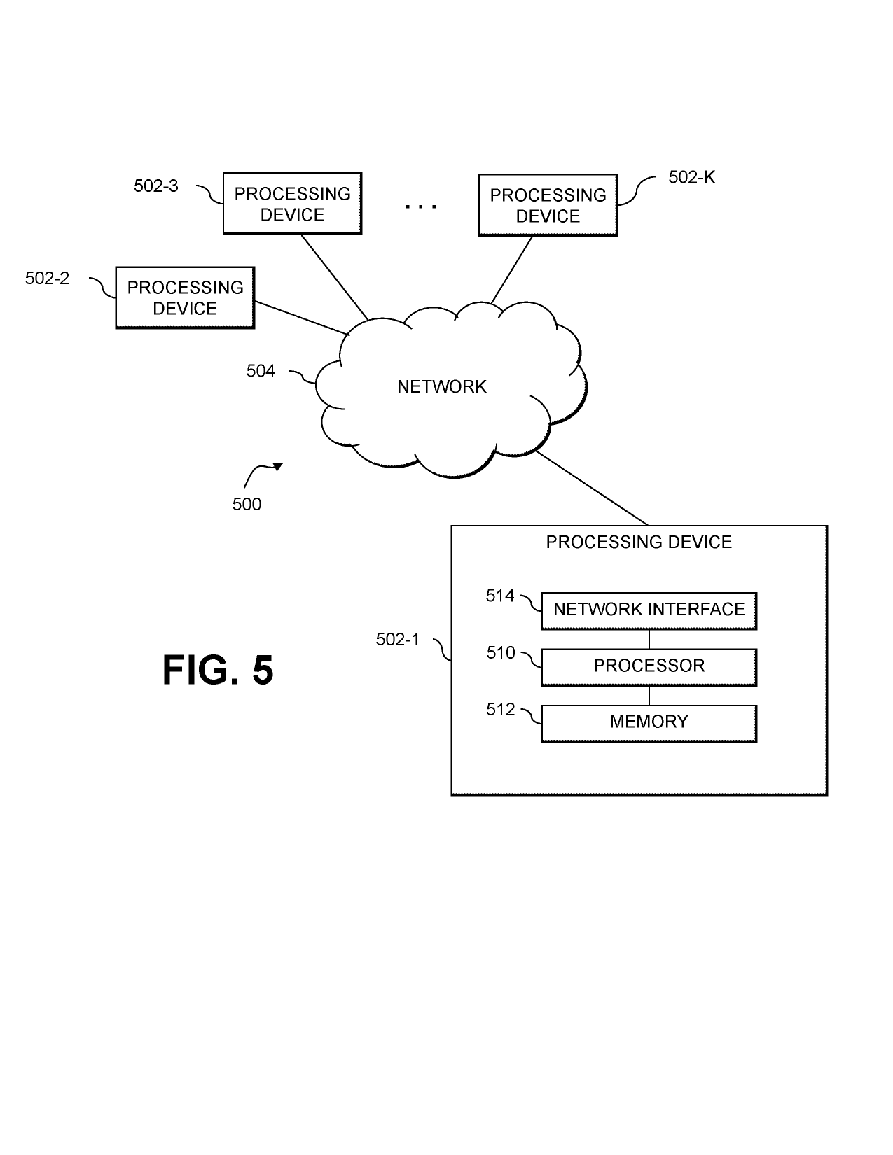

Additional examples of processing platforms utilized to implement portions of the system 100 in illustrative embodiments will be described in more detail below in conjunction with FIGS. 4 and 5.

It is to be understood that the particular set of elements shown in FIG. 1 for detection of anomalous write patterns in a write journal of a storage system is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

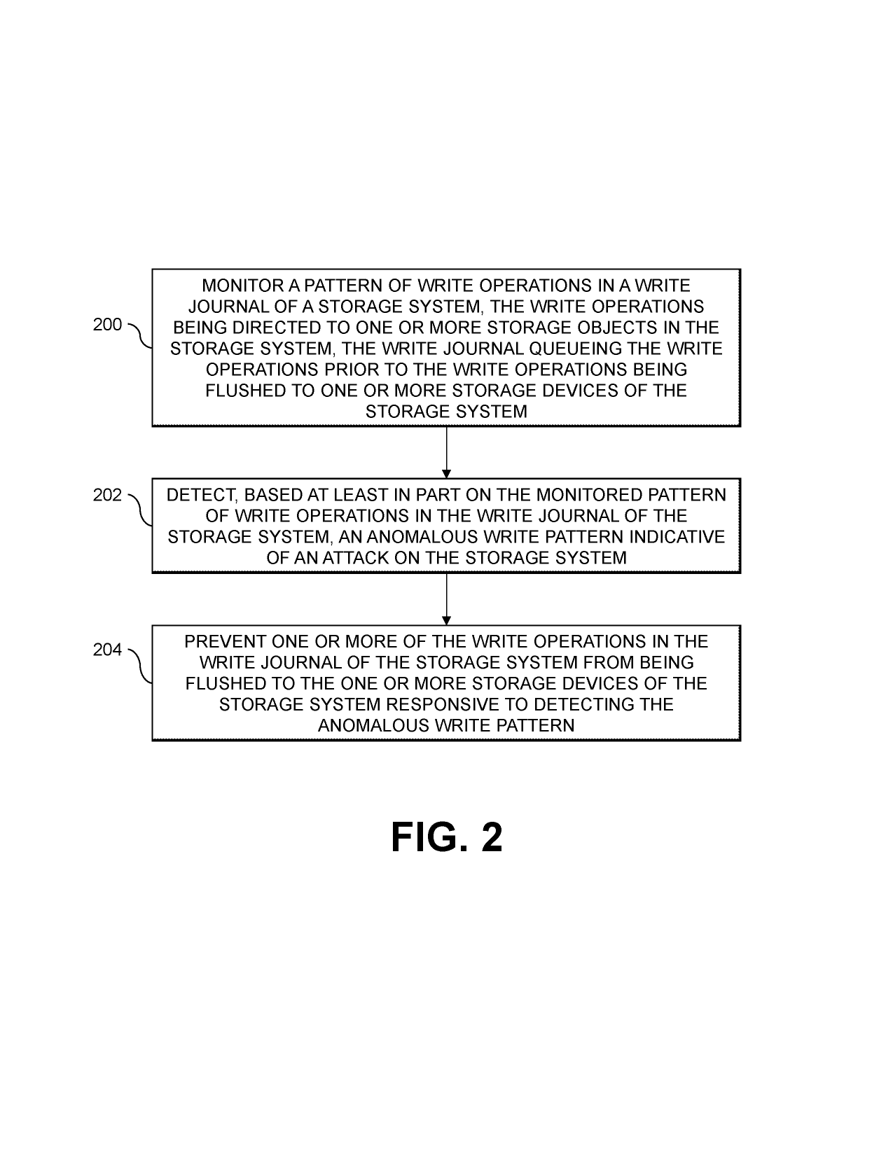

An exemplary process for detection of anomalous write patterns in a write journal of a storage system will now be described in more detail with reference to the flow diagram of FIG. 2. It is to be understood that this particular process is only an example, and that additional or alternative processes for detection of anomalous write patterns in a write journal of a storage system.

In this embodiment, the process includes steps 200 through 204. These steps are assumed to be performed by the IO cache monitoring logic 116 and the anomalous write pattern detection logic 118. The process begins with step 200, monitoring a pattern of write operations in a write journal of a storage system, the write journal queueing the write operations directed to one or more storage objects in the storage system prior to the write operations being flushed to one or more storage devices of the storage system. In step 202, an anomalous write pattern indicative of an attack on the storage system is detected based at least in part on the monitored pattern of write operations in the write journal of the storage system. In step 204, responsive to detecting the anomalous write pattern, one or more of the write operations in the write journal of the storage system are prevented from being flushed to the one or more storage devices of the storage system.

The FIG. 2 process may further include monitoring a pattern of read operations in a read cache of the storage system, the read operations being directed to one or more storage objects stored in the one or more storage devices of the storage system. Detecting the anomalous write pattern in step 202 may be further based at least in part on correlating (i) one or more of the read operations in the read cache of the storage system directed to a given one of the storage objects stored in the one or more storage devices of the storage system with (ii) one or more of the write operations in the write journal of the storage system directed to the given storage object. The anomalous write pattern may comprise detection of a write after read pattern in which at least one of the one or more storage objects is read and then written back in an encrypted format.

In some embodiments, the anomalous write pattern comprises detection of at least a threshold change in entropy of at least one of the one or more storage objects. The anomalous write pattern may also or alternatively comprise detection of at least a threshold number of sequential writes to data blocks in the one or more storage devices of the storage system. The sequential writes to the data blocks may comprise sequential writes of encrypted data. The anomalous write pattern may further or alternatively comprise detection of at least a threshold change in an amount of encrypted data that is being written to the storage system.

The FIG. 2 process may further include, responsive to detecting the anomalous write pattern, determining a subset of the one or more storage objects of the storage system that are a target of the attack on the storage system. Step 204 may include preventing ones of the write operations in the write journal that are directed to the subset of the one or more storage objects of the storage system that are the target of the attack on the storage system from being flushed to the one or more storage devices of the storage system. In other embodiments, step 204 includes preventing all write operations in the write journal of the storage system from being flushed to the one or more storage devices of the storage system.

In some embodiments, the FIG. 2 process also includes, responsive to detecting the anomalous write pattern: determining a subset of the one or more storage objects of the storage system that are a target of the attack on the storage system; and stopping read and write operations directed to the subset of the one or more storage objects of the storage system that are the target of the attack on the storage system.

In some embodiments, the FIG. 2 process also includes, responsive to detecting the anomalous write pattern: discarding one or more of the write operations in the write journal that are determined to be directed to a subset of the one or more storage objects of the storage system that are the target of the attack on the storage system; or sending one or more of the write operations in the write journal that are determined to be directed to the subset of one or more storage objects of the storage system that are the target of the attack on the storage system to a quarantined storage area.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different processes, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

As discussed above, storage arrays or other types of storage systems may be subject to various types of malicious activity, including ransomware attacks in which an attacker installs malware infecting one or more processing devices, where the malware systematically encrypts files or other data on storage systems. The attacker withholds the corresponding decryption key unless a ransom is paid. Various techniques may be used to combat against ransomware attacks, including looking for Indications of Compromise (IOCs) in the data that is written to a storage system. The IOCs may include, for example, file names, data patterns, data access patterns, a change in entropy of the data stored on a storage system, etc. Techniques used to look for these and other IOCs are generally divided into two categories: background detection and real-time detection.

In background detection approaches, searching for IOCs may include scanning a data set, analyzing changes between point-in-time images of the data set, etc. Scanning looks at the data on the storage system without any temporal information. Analyzing the changes between point-in-time images improves on scanning, by having coarse-grained temporal information based on the frequency of the point-in-time images. Technical challenges with background detection approaches include that, upon detection of a ransomware attack, the damage to the data is already done. Moreover, in advanced storage systems, data is often compressed or deduplicated. Further, background detection approaches often incur additional data or metadata overhead to analyze the data in the background.

In real-time detection approaches, a data stream is analyzed as the data arrives at the storage system. Key metrics of the data are kept, along with temporal information such as entropy and access patterns to be used for detection. Real-time detection approaches are typically more responsive than background detection approaches, but real-time detection approaches are also typically more resource-intensive than background detection approaches. Further, while real-time detection approaches perform analysis in real-time, by the time an attack is detected (e.g., such as through determining that a threshold of high entropy data has been exceeded) some damage to the data has already occurred, though the amount of damage may be smaller than that which occurs in background detection approaches.

Illustrative embodiments provide technical solutions for leveraging storage journaling to provide improved ransomware and other malicious activity detection, prevention and remediation in storage systems.

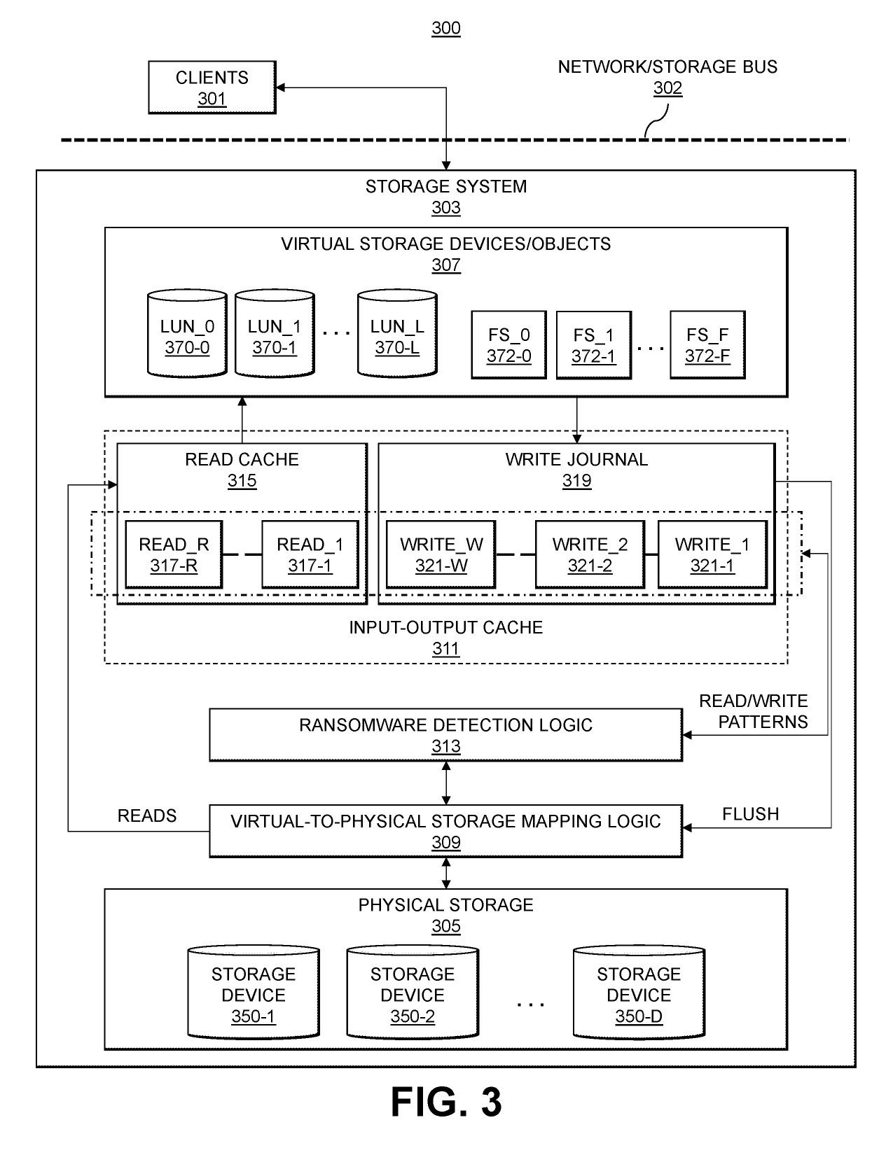

FIG. 3 shows an information processing system 300 including one or more clients 301 which are connected to a storage system 303 via a network or storage bus 302. The clients 301 may connect to the storage system 303 on the network or storage bus 302 using various storage protocols, including but not limited to Network File System (NFS), Common Internet File System (CIFS), NVMeoF, etc. The storage system 303 comprises physical storage 305 including a set of storage devices 350-1, 350-2, . . . 350-D (collectively, storage devices 350). The storage system 303 presents a virtual name space to the clients 301, shown in FIG. 3 as the virtual storage devices/object 307, including one or more LUNs such as LUN_0370-0, LUN_1370-1, . . . LUN_L 370-L (collectively, LUNs 370) and one or more filesystems (FSs) such as FS_0372-0, FS_1372-1, . . . FS_F 372-F (collectively, FSs 372). The storage system 303 utilizes virtual-to-physical storage mapping logic 309 to map between the virtual name space (e.g., the virtual storage devices/objects 307) and the physical storage 305. The mapping functions can be file system directories and files, virtual sparse block devices, etc. The storage system 303 further comprises an IO cache 311, including a read cache 315 and a write journal 319. In some cases, the read cache 315 and the write journal 319 (also referred to as a write cache) are part of the same larger IO cache 311, though this is not a requirement. In other cases, the read cache 315 and the write journal 319 may be implemented as separate and distinct caches, and thus the IO cache 311 is shown in dashed outline in FIG. 3.

As the storage system 303 receives data and metadata read requests from the clients 301 across the virtual storage devices/objects 307 of the virtual name space, reads including Read_1317-1, …., 317-R (collectively, reads 317) are queued in the read cache 315. The virtual-to-physical storage mapping logic 309 will monitor the read cache 315, and will retrieve the data/metadata for the reads 317 from the physical storage 305 and return it to the read cache 315, which in turn provides the retrieved data/metadata to the requesting clients 301 via one or more of the virtual storage devices/objects 307 in the virtual name space.

As the storage system 303 receives data and metadata writes from the clients 301 directed to the virtual storage devices/objects 307 of the virtual name space, such writes are first recorded in the write journal 319 as Write_1321-1, Write_2321-2, . . . Write_W 321-W (collectively, writes 321). This allows for better response time to the clients 301, avoiding latency associated with metadata processing and/or performing advanced storage functions such as compression and deduplication, which often require multiple write requests to be processed together for efficiency. Once the write processing is done, the data or blocks of data are “flushed” to a mapping layer (e.g., the virtual-to-physical storage mapping logic 309) to map and write the data to the physical storage 305.

The technical solutions described herein leverage the write journal 319, where multiple writes (e.g., the writes 321) and their temporal data are known. The storage system 303 implements ransomware detection logic 313, which is configured to run one or more ransomware detection algorithms on the journaled data (e.g., the writes 321) to detect read and/or write patterns to detect ransomware attacks before the data is flushed from the write journal 319 to the mapping layer (e.g., the virtual-to-physical storage mapping logic 309). The ransomware detection logic 313 may also utilize data and metadata read metrics (e.g., for the reads 317 in the read cache 315) to improve the ransomware detection performance. The ransomware detection logic 313 is advantageously configured to detect ransomware attacks before damage is done (e.g., before data is flushed from the write journal 319 and actually written to the physical storage 305). The ransomware detection logic 313 is configured to leverage knowledge of the read/write patterns captured in the read cache 315 and the write journal 319 holistically in order to detect ransomware attacks.

In the storage system 303 having the write journal 319, the ransomware detection logic 313 can advantageously take advantage of the data of the writes 321 and the temporal data inherent in the write journal 319. When combined with the pattern of the reads 317 in the read cache 315, the ransomware detection logic 313 is configured to detect ransomware attacks or other types of anomalous read/write patterns indicative of malicious or potentially malicious activity. To do so, the ransomware detection logic 313 may utilize various metrics, machine learning algorithms, etc. Thus, the ransomware detection logic 313 provides the opportunity to stop attacks before information stored in the physical storage 305 is damaged.

The ransomware detection logic 313 may utilize various techniques to analyze the read/write patterns in the read cache 315 and the write journal 319. For example, the ransomware detection logic 313 may determine entropy and segment entropy changes in the read/write patterns. In a ransomware or other type of encryption attack, the entropy of blocks and segments will change very quickly. The write journal 319 can be used to detect this behavior before the writes 321 are committed to permanent storage (e.g., on the storage devices 350 of the physical storage 305). As another example, the ransomware detection logic 313 may determine sequentiality of the read/write patterns. In a ransomware attack, many encrypted blocks will be written sequentially. In cases where encryption is used sparingly on parts of files or metadata, the write journal 319 can “see” the writes 321 to all the files and can detect more attack patterns. As a further example, the ransomware detection logic 313 may determine “write after read” read/write patterns. In most ransomware attacks, data is read and then written back encrypted with an attacker key. By combining the pattern of the writes 321 in the write journal 319 and the pattern of the reads 317 in the read cache 315, this behavior can be detected.

Once the ransomware detection logic 313 detects a ransomware or other type of attack or anomalous behavior that is malicious or potentially malicious, a policy-based response may be initiated. Parameters of the policies include the classification of the data, confidence of a positive detection, preference of the user of the data, etc. If the storage system 303 utilizes block-based storage, the policies may be configured per volume. If the storage system 303 utilizes file-based storage, the policies may be configured per filesystem, per directory, or even per file. The policies may include: stopping all IOs on the storage system 303; stopping IOs to the storage objects (e.g., virtual storage devices/objects 307) that are under attack; stopping flushing of ones of the writes 321 that are directed to the storage objects under attack, or stopping flushing of the writes 321 altogether; etc.

With the write journal 319, it is typical that the writes 321 are clearly associated with certain storage objects (e.g., virtual storage devices/objects 307). When an attack is detected before the writes 321 are flushed to permanent storage (e.g., the physical storage 305), recovery methods include: discarding the malicious changes; sending the writes 321 to a quarantined area or region (e.g., of the physical storage 305 or other storage devices/systems). In some cases, the storage system 303 implements a journaling system in which the writes 321 in the write journal 319 are considered committed writes. In such cases, similar recovery methods may be utilized, though a user may need to direct the recovery as it affects the client view of the committed data. The state of the storage objects will remain the same as before the attack.

Ransomware attacks are constantly on the rise. Layered protection coupled with ease of recovery provides businesses, organizations and other enterprises and entities the means to minimize disruptions resulting from ransomware attacks. The technical solutions described herein, through leveraging a write journal to scrutinize writes before they are flushed to permanent storage, provide a unique opportunity to look at access patterns with a certain amount of temporal information. Because the write journal is naturally storage object-aware, it also provides a convenient recovery platform to minimize down time and disruption. The technical solutions described herein are advantageously able to leverage the characteristics of write journals in storage systems to detect ransomware attacks and threats before writes are committed, and/or before writes are flushed from the write journal to physical storage.

Analyzing write patterns in a write journal has technical advantages, in that the write journal provides temporal information of the writes directed to storage objects. This is especially effective when coalesced with the read patterns of the same storage objects. Further, analyzing the writes in the write journal across storage objects provides an aggregate view of what is happening in the storage system. The technical solutions described herein are further able to respond to detected ransomware or other attacks or patterns of malicious or potentially malicious activity, such as through policy-driven responses that apply to parts of the storage system or the whole storage system. Individual storage objects can be quarantined, or turned read-only without shutting down the whole storage system. In some embodiments, recovery is as simple as discarding uncommitted malicious writes. In cases where writes in the write journal are considered committed, the temporal information in the write journal provides fine-grained recovery options. As ransomware attacks and their resulting damage constantly increase, there is a growing need for providing storage systems that are resilient to ransomware attacks. Having the capability to detect ransomware or other attacks in the write journal not only provides fast and accurate detection, but also provides improvements in the response to and recovery from ransomware or other attacks or patterns of malicious or potentially malicious activity.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for detection of anomalous write patterns in a write journal of a storage system will now be described in greater detail with reference to FIGS. 4 and 5. Although described in the context of system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that may be utilized to implement at least a portion of the information processing system 100 in FIG. 1. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 may comprise respective VMs, respective sets of one or more containers, or respective sets of one or more containers running in VMs.

In some implementations of the FIG. 4 embodiment, the VMs/container sets 402 comprise respective VMs implemented using virtualization infrastructure 404 that comprises at least one hypervisor. A hypervisor platform may be used to implement a hypervisor within the virtualization infrastructure 404, where the hypervisor platform has an associated virtual infrastructure management system. The underlying physical machines may comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of system 100 and includes a plurality of processing devices, denoted 502-1, 502-2, 502-3, . . . 502-K, which communicate with one another over a network 504.

The network 504 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 502-1 in the processing platform 500 comprises a processor 510 coupled to a memory 512.

The processor 510 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 512 may comprise random access memory (RAM), read-only memory (ROM), flash memory or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for detection of anomalous write patterns in a write journal of a storage system as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, storage systems, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to monitor a pattern of write operations in a write journal of a storage system, the write operations being directed to one or more storage objects in the storage system, the write journal queueing the write operations prior to the write operations being flushed to one or more storage devices of the storage system;
to detect, based at least in part on the monitored pattern of write operations in the write journal of the storage system, an anomalous write pattern indicative of an attack on the storage system; and
responsive to detecting the anomalous write pattern, to prevent one or more of the write operations in the write journal of the storage system from being flushed to the one or more storage devices of the storage system.

2. The apparatus of claim 1 wherein the at least one processing device is further configured to monitor a pattern of read operations in a read cache of the storage system, the read operations being directed to one or more storage objects stored in the one or more storage devices of the storage system.

3. The apparatus of claim 2 wherein detecting the anomalous write pattern is further based at least in part on the monitored pattern of read operations in the read cache of the storage system.

4. The apparatus of claim 2 wherein detecting the anomalous write pattern is further based at least in part on correlating (i) one or more of the read operations in the read cache of the storage system directed to a given one of the storage objects stored in the one or more storage devices of the storage system with (ii) one or more of the write operations in the write journal of the storage system directed to the given storage object.

5. The apparatus of claim 2 wherein the anomalous write pattern comprises detection of a write after read pattern in which at least one of the one or more storage objects is read and then written back in an encrypted format.

6. The apparatus of claim 1 wherein the anomalous write pattern comprises detection of at least a threshold change in entropy of at least one of the one or more storage objects.

7. The apparatus of claim 1 wherein the anomalous write pattern comprises detection of at least a threshold number of sequential writes to data blocks in the one or more storage devices of the storage system.

8. The apparatus of claim 7 wherein the sequential writes to the data blocks comprise sequential writes of encrypted data.

9. The apparatus of claim 1 wherein the anomalous write pattern comprises detection of at least a threshold change in an amount of encrypted data that is being written to the storage system.

10. The apparatus of claim 1 wherein the at least one processing device is further configured, responsive to detecting the anomalous write pattern, to determine a subset of the one or more storage objects of the storage system that are a target of the attack on the storage system, wherein preventing one or more of the write operations in the write journal of the storage system from being flushed to the one or more storage devices of the storage system comprises preventing ones of the write operations in the write journal that are directed to the subset of the one or more storage objects of the storage system that are the target of the attack on the storage system from being flushed to the one or more storage devices of the storage system.

11. The apparatus of claim 1 wherein the at least one processing device is further configured, responsive to detecting the anomalous write pattern:
to determine a subset of the one or more storage objects of the storage system that are a target of the attack on the storage system; and
to stop read and write operations directed to the subset of the one or more storage objects of the storage system that are the target of the attack on the storage system.

12. The apparatus of claim 1 wherein preventing one or more of the write operations in the write journal of the storage system from being flushed to the one or more storage devices of the storage system comprises preventing all write operations in the write journal of the storage system from being flushed to the one or more storage devices of the storage system.

13. The apparatus of claim 1 wherein the at least one processing device is further configured, responsive to detecting the anomalous write pattern, to discard one or more of the write operations in the write journal that are determined to be directed to a subset of the one or more storage objects of the storage system that are a target of the attack on the storage system.

14. The apparatus of claim 1 wherein the at least one processing device is further configured, responsive to detecting the anomalous write pattern, to send one or more of the write operations in the write journal that are determined to be directed to a subset of the one or more storage objects of the storage system that are a target of the attack on the storage system to a quarantined storage area.

15. A computer program product comprising a non-transitory processor-readable storage medium having stored therein program code of one or more software programs, wherein the program code when executed by at least one processing device causes the at least one processing device:
to monitor a pattern of write operations in a write journal of a storage system, the write operations being directed to one or more storage objects in the storage system, the write journal queueing the write operations prior to the write operations being flushed to one or more storage devices of the storage system;
to detect, based at least in part on the monitored pattern of write operations in the write journal of the storage system, an anomalous write pattern indicative of an attack on the storage system; and
responsive to detecting the anomalous write pattern, to prevent one or more of the write operations in the write journal of the storage system from being flushed to the one or more storage devices of the storage system.

16. The computer program product of claim 15 wherein the program code when executed by the at least one processing device further causes the at least one processing device to monitor a pattern of read operations in a read cache of the storage system, the read operations being directed to one or more storage objects stored in the one or more storage devices of the storage system.

17. The computer program product of claim 16 wherein detecting the anomalous write pattern is further based at least in part on the monitored pattern of read operations in the read cache of the storage system.

18. A method comprising:
monitoring a pattern of write operations in a write journal of a storage system, the write operations being directed to one or more storage objects in the storage system, the write journal queueing the write operations prior to the write operations being flushed to one or more storage devices of the storage system;
detecting, based at least in part on the monitored pattern of write operations in the write journal of the storage system, an anomalous write pattern indicative of an attack on the storage system; and
responsive to detecting the anomalous write pattern, preventing one or more of the write operations in the write journal of the storage system from being flushed to the one or more storage devices of the storage system;
wherein the method is performed by at least one processing device comprising a processor coupled to a memory.

19. The method of claim 18 further comprising monitoring a pattern of read operations in a read cache of the storage system, the read operations being directed to one or more storage objects stored in the one or more storage devices of the storage system.

20. The method of claim 19 wherein detecting the anomalous write pattern is further based at least in part on the monitored pattern of read operations in the read cache of the storage system.
